(19) United States
(12) Patent Application Publication
(10) Pub. No.: US 2024/0013310 A1
(43) Pub. Date: Jan. 11, 2024

(54) FULLY INTEGRATED AND EMBEDDED MEASURING SYSTEM DIRECTED TO A SCORE-INDEXING PARAMETER ESSENTIALLY BASED ON DIRECTLY MEASURED CONNECTED MOTOR VEHICLE SENSORY DATA AND METHOD THEREOF

(71) Applicant: Swiss Reinsurance Company Ltd., Zürich (CH)

(72) Inventor: Luigi DI LILLO, Zürich (CH)

(73) Assignee: Swiss Reinsurance Company Ltd., Zürich (CH)

(21) Appl. No.: 18/370,252

(22) Filed: Sep. 19, 2023

Related U.S. Application Data
(63) Continuation of application No. PCT/EP2022/073881, filed on Aug. 29, 2022.

(30) Foreign Application Priority Data
Aug. 27, 2021 (CH) 070215/2021

(51) Int. Cl. G06Q 40/08; G07C 5/08

(52) U.S. Cl. CPC G06Q 40/08; G07C 5/0841

(57) ABSTRACT

Proposed is an automated, fully integrated, and embedded measuring system and method for measuring a score-indexing parameter essentially based on directly measured connected motor vehicle sensory data and/or sensory data of a mobile device of a user of the motor vehicle. The sensory data stem from a change in status of the vehicle at any point in time, due to i) the actions/reaction of the driver, ii) the context in which the driver is driving or, the way the driver perceives and feels the surroundings, iii) the way the car adapts to internal and external conditions, including the driver. The measured score-indexing parameter captures (i) vehicle component impacts by which systems are present and activated/deactivated, (ii) driver component impact comprising at least measured harsh maneuvers and/or excess of speed and/or risky behaviors and/or distraction, and (iii) contextual component impacts where vehicle data are enriched with additional layers to measure location-based risks.

### CROSS REFERENCE TO RELATED APPLICATIONS

The present application is a continuation application of International Patent Application No. PCT/EP2022/073881, filed Aug. 29, 2022, which is based upon and claims the benefits of priority to Swiss Application No. 070215/2021, filed Aug. 27, 2021. The entire contents of all of the above applications are incorporated herein by reference.

### FIELD OF THE INVENTION

The present invention relates to connected motor vehicle sensory systems, and methods for measuring vehicle-specific probability measuring parameters for the occurrence probability of impacting physical events, in particular an accident event, to a concerned motor vehicle. Connected motor vehicles can e.g. denote cars, trucks, motorcycles, maritime vessels, aircrafts, planes, or any other connected transportation systems. More general, the present invention relates to vehicle-specific real-time sensory data acquisition and processing systems, and particularly to measuring system for system-controlled monitoring motor vehicle operational characteristics, driver behavior and contextual sensory data, holistically capturing and uniformly processing of increased amounts of heterogeneous sensory data relating to the measured and predicted probability of an occurrence of physically impacting events to a specific motor vehicle. The predicted probability measuring parameter value for the occurrence of a certain physically event impacting with a measurable impacting strength to the motor vehicle in a defined future time window is sometimes also referred to as measured risk exposure value. Sometimes this measuring values is somewhat blurred simply referred to as “risk”. However, in the technical filed of the present system, this term should be avoided without giving a clear technical definition, since the measured risk as such can either refer to the measured probability value for the occurrence of the physical event in a certain time window and geographical location, as such, or to the measured probability value for the occurrence of the physical event having a certain impacting strength to the risk-exposed object being in the certain time window at the geographic location. Thus the time-related risk exposure value is a physically measurable time related measuring parameter averaged over a measured time series of occurrence rates in defined, future time windows. Finally, the present invention also generally relates to automated systems for measuring vehicle accident probability values allowing to optimize and increase vehicular operation and safety and, more particularly, to dynamically providing real-time monitoring and vehicle control based on measured safety and associated risks.

### BACKGROUND OF THE INVENTION

Motor vehicles, such as automobiles and other types of vehicles used for transportation are usually regarded as technically essential to many activities for a large proportion of the population. Since such vehicles can be subject to damage or destruction by the occurrence of physically impacting events, as an accident event. and can cause personal injury and/or property damage during those events that are largely unpredictable, they have been objects of risk transfer technology and insurance systems against the impact of the occurrence of such accident events impacting a physical damage measurable and indexable by providing a monetary loss measure representing the level of physical damage. Most countries even mandatory require a risk-cover for possibly occurring accident events as pre-condition of licensing for operation of a vehicle while many vehicles are further covered against the replacement cost for resolving the impact of the damage to the vehicle, itself. However, the rise of telematics-supported usage-based insurance (UBI) has introduced a new technical based era in the world of vehicle risk-transfer and measurements.

The development of many technologies such as arrays of air bags and computerized engine regulation, light weight and/or impact absorbing materials and parts and exhaust gas treatment which support enhanced safety and reduced environmental impact of the use of such vehicles have become more and more common and the inclusion of such technologies in currently produced vehicles has even been mandated by regulation while their inclusion has often raised the cost of vehicles to a significant degree and thus the loss associated with a possible physical damage. Any such increase in cost, of course, increases the potential loss to be covered by the risk-transfer system and risk-transfer premiums based principally on vehicle cost have increased accordingly to the point of compromising the ability of some vehicle users to procure and maintain adequate risk-transfer/insurance. Therefore, risk-transfer providers have sought to potentially reduce premiums based on the driving records of users and prior claims. However, driving records can contain only historical information and are usually insufficiently complete to accurately reflect the driving habits of particular vehicle users and thus may not accurately measure and predict actual driving habits or the increase or reduction of the transferred risk to the risk-transfer system.

However, in the recent years, digital transformation has led to an increased interest in using and utilizing smart and/or real-time measuring technology (as e.g. wearables or telematics) in various technical risk-transfer approaches, something that has come to challenge the traditional purely statistical insurance structures. The Usage-Based Insurance model (UBI) is an example of a risk-transfer structure that is based on such technological innovations. With the aid of telematics and/or smart technology, new technical capabilities could be introduced to the transfer of risk, by using real-time data, to dynamically price the transfer, and dynamically generating more accurate premiums more efficiently, as well as it enables a more proactive technical approach. Despite this positive capabilities, the degree of implementation can generally be regarded as low. Thus, the interest is raised about what influences this low level of implementation, as well as what challenges, requirements and consequences that are attached to such implementation. By investigating for example the UBI approach, the purpose of this study is thus to analyze how new technology-based risk-transfer structures can affect the risk-transfer industry and, in an extension, also the risk-transfer landscape.

In general, there are three broad categories of change related to the opportunities of new technology. The first two are related to how new technologies (chatbots, Robo-advisors etc.) and automated data processing and analytics change how individuals and insurers interact with each other and how risk-transfer can be applied for improving the efficiency of the risk-transfer processes, for example by automation. The last category of change is related to the fact that new technologies can create opportunities for insurers to modify their existing risk-transfer structures toward becoming more agile and tailor-made and being relied on technical means and technical methods. The opportunities with new technology, especially the last category, have gained much attention from the insurance industry as this provides the insurer with an increased ability to meet the new customer demand and the new competitive environment.

Furthermore, through these new technologies and the new working methods that follow, risk-transfer technology has an increased opportunity to meet the needs of the users in a whole new way. Connected devices, such as smart watches, and advanced data processing and analysis, allow to offer individuals “smart insurances” and “smart risk-transfers”; technology-based insurance processes tailored to the individuals' needs and lifestyles. Smart insurances, based on the individual's needs and lifestyle will become increasingly important for insurers to create a strong relationship and loyalty to the policyholders and thus stay competitive on a market that is becoming increasingly affected by the digitalization.

Especially, in the world of automobile insurance, the development of telematics-supported usage-based insurance (UBI) has ushered a new era of risk-transfer. Vehicle telematics, integrated navigation, and computer and mobile communication technology used to directly monitor driving behavior allow insurers to actually measure and use true causal risk factors to accurately assess risks and develop precise UBI rating and measurement. Furthermore, with premiums accurately reflecting true risks, policyholders are incentivized to adopt risk-minimizing behaviors with benefits accruing not only to consumers and risk-transfer providers. These benefits are propelling the insurance technology to quickly expand the availability of telematics-based UBI structures.

In particular, in the effort to obtain more current measuring data from which driving habits can be assessed in regard to accident-related risk exposure under a risk-transfer policy, various systems have been proposed to measure and aggregate data concerning operation of respective vehicles on a substantially real-time basis. Such data can then be processed to provide a more accurate measurement and/or assessment of driving habits and the relative risks, i.e. the individual provability of the occurrence of a physical accident event with a physical impact, that may be projected from such driving habits and/or environmental context. Many, if not most, of the technical arrangements that have been proposed to perform such a function provide for collection of information only upon the occurrence of events such as excessive longitudinal or lateral acceleration that are perceived to be correlated with a risk of an actual impact and are, hence, very coarse-grained in the information provided. Further, generation of events that cause reportage may not accurately reflect the true, actually measured risk incident to particular qualities of individual driving habits and, moreover, may not allow such information to be optimally current. Unfortunately, making collected data more fine-grained by altering thresholds of vehicle operation condition events which will cause an event to be reported goes along with a strongly increased vehicle operating conditions to be reported and transmitted as well as with an increased storage and processing of increased amounts of collected vehicle operating condition data. Further, such increased volume of collected data due to alteration of reporting thresholds will be incrementally less and less correlated with the actual risk.

In spite of all, many motor vehicles, irrespectively of air-based, air-based, or maritime vehicles, include sensors and internal monitoring and data capturing systems designed to store and monitor driving data, vehicle operation data, driving conditions, contextual conditions, and driving functions. Many vehicles also include one or more communication systems, in particular wireless communication systems, designed to send and receive information, such as sensory data or other information data, from inside or outside the vehicle. Such information can include, for example, vehicle operational data, driving conditions, and communications from other vehicles or centralized/decentralized systems. However, these possibilities are not use due to the deficiencies, discussed above, and most of the risk-transfer systems still rely on conventional methods for determining costs of motor vehicle related risk-transfer involve gathering relevant historical data from a personal interview with the applicant for performing the risk-transfer and often by referencing the applicant's public motor vehicle driving record that is maintained by a governmental agency or the like. Such data results in a classification of the applicant to a broad so-called preferred class for which risk-transfer rates are assigned based upon the empirical experience or historical statistics. Many factors are relevant to such classification in a particular actuarial class, such as age, sex, marital status, location of residence and driving record. Most current risk-transfer system creates groupings of vehicles and drivers (preferred classes) based, for example, on the following types of classifications: (i) Vehicle: age, manufacturer, model, and replacement value; (ii) Driver: age, sex, marital status, driving record (based on government reports), violations (citations), at fault accidents, and place of residence; (iii) Coverage: types of losses covered, liability, uninsured motorist, comprehensive and collision, liability limits, and deductibles. The classifications, such as age, are further broken into preferred classes, such as 21 to 24, to develop a unique vehicle risk-transfer cost based on the specific combination of preferred classes associated with a particular risk exposure. A change to any of this information would result in a different premium associated with the risk-transfer if the change resulted in a different preferred class for that variable. For instance, a change in the drivers age from 38 to 39 may not result in a different preferred class, because 38 and 39 year old people may be in the same preferred class. However, a change in driver age from 38 to 45 may result in a different premium because it results in a change in the preferred class.

One of the problems with such conventional risk-transfer assessments is that much of the data gathered from the applicant in the interview is technically or otherwise not verifiable, and even existing public records contain only minimal information, much of which has little relevance towards an assessment of the actual likelihood of a claim subsequently occurring. In other words, current rating systems are primarily based on past realized losses. None of the data obtained through conventional systems necessarily reliably predicts the manner or safety of future operation of the vehicle. Accordingly, the limited amount of accumulated relevant data and its minimal evidential value towards computation of a fair cost for the risk-transfer has generated a long-felt need for an improved system for more reliably and accurately accumulating data having a highly relevant evidential value towards technically measuring and predicting the actual manner of a vehicle's future operation.

Many types of vehicle operating data recording systems have heretofore been suggested for purposes of maintaining an accurate record of certain elements of vehicle operation. Some are suggested for identifying the cause for an accident, others are for more accurately assessing the efficiency of operation. Such systems disclose a variety of conventional techniques for recording vehicle operation data elements in a variety of data recording systems. In addition, it has also been suggested to provide telematics data over a radio communication link for such information via systems such as a cellular telephone to provide immediate communication of certain types of data elements or to allow a more immediate response in cases such as theft, accident, break-down or emergency. It has also been suggested to detect and record safety features, such as seatbelt usage, to improve exact determination of the vehicle risk-transfer premiums.

The various forms and types of vehicle operating data acquisition and recording systems that have heretofore been suggested and employed have met with varying degrees of success for their express limited purposes and limited data access. All possess substantial defects such that they have only limited economical and practical value for a system intended to provide an enhanced acquisition, recording and communication system of data which would be both comprehensive and reliable in predicting an accurate and adequate cost of a risk-transfer for the vehicle. Since the type of operating information acquired and recorded in prior art systems was generally never intended to be used for measuring risk-exposure and automatically determining the adequate premiums of vehicle risk-transfer, the data elements that were monitored and recorded therein were not directly related to predetermined safety standards or the determining of an actuarial class for the vehicle operator. For example, recording data characteristics relevant to the vehicle's operating efficiency may be completely unrelated to the safety of operation of the vehicle. Further, there is the problem of recording, selecting/filtering and subsequently processing/compiling the large amount of accruing real-time sensory data for an accurate measuring of a parameter-based profile and an appropriate risk-transfer cost, therefor.

Current motor vehicle control and operating systems comprise electronic systems readily adaptable for modification to obtain the desired types of information relevant to measuring of the actual risk-exposure. Vehicle tracking systems have been suggested which use communication links with satellite navigation systems for providing sensory data describing a vehicle's location based upon navigation signals. When such positioning information is combined with roadmaps in an expert system, vehicle location is ascertainable. Mere vehicle location, though, does not provide data particularly relevant to safety of operation unless the data is combined with other relevant data in an expert system which is capable of assessing whether the roads being driven are high-risk or low-risk with regard to vehicle safety. Thus, there is a technical need for a measuring system based on a uniform approach to the large amount of real-time accruing sensory data.

The prior art document US 2019/0102840 A1 shows an electronic, real-time system for maneuver recognition of vehicles based on dynamically measured telematics and sensory data of smartphone sensors, essentially or solely being based on data measured by the accelerometer sensor, the global positioning system (GPS) sensor, and the gyroscope sensor of a smartphone. In this system, the axes of the smart-phone may be moving independently relative to the axes of the vehicle and thus do not need to be aligned with the axes of the vehicle. Driver behaviors and operational parameters are discriminated based on individuated driver maneuvers to vehicle trajectories, and an output signal is generated based upon derived risk measure parameters and/or crash attitude measure parameters. Further, the prior art document WO 2017/157449 A1 shows a machine-learning based telematics system having mobile telematic sensors associated with motor vehicles. A machine-learning based circuit generates first risk transfer parameters and correlated first payment transfer parameters and transmits them to a first risk-transfer system. In the case of triggering the occurrence of an accident event, a loss is automatically covered by the first risk-transfer system. Second risk transfer parameters are generated by means of the machine-learning based telematics system and transmitted to the second risk-transfer system, wherein the occurred loss (is at least partly covered by the second insurance system. The first and second risk transfer parameters are mutually adapted by the machine-learning based telematics circuit based on the measured telematics data. The document Alsrehin N. et al “Intelligent Transportation and Control Systems Using Data Mining and Machine Learning Techniques: A Comprehensive Study, Apr. 25, 1019 pages 49830-49857 shows different approaches to transportation and traffic management system using data mining and machine learning. The system, inter alia, proposes the machine learning for predicting real-time traffic flow and short-term traffic flow in heterogenous conditions. Finally, the document Chen et al, Driving behaviors analysis based on feature selection and statistical approach: a preliminary study, Sep. 24 2018, pages 2007-2026, shows another system for fleet management, where fleet administrators are supported by in fine-grained information about fleet usage, which is influenced by different driver usage patterns based on feature selection and statistical approach. Feature selection is used in data preprocessing for big data mining of the fleet data captured. For dimensionality reduction, the feature selection chooses a small subset of the significant features from the data by removing redundant features. Afterward, the statistical approach calculates skewness and dispersion in speed distribution as the statistical features for driving behaviors analysis.

### SUMMARY OF THE INVENTION

It is one object of the present invention to provide a fully integrated and embedded measuring system and method directed, inter alia, to measure a holistic score-indexing measuring parameter in real-time, which is essentially based on directly (real-time or near-real-time) measured connected motor vehicle sensory data. The invention shall provide a unified data-capturing and measuring solution based primarily on the data produced directly by the vehicle.

According to the present invention, these objects are achieved, particularly, with the features of the independent claims. In addition, further advantageous embodiments can be derived from the dependent claims and the related descriptions.

According to the present invention, the above-mentioned objects for an automated, fully embedded, machine-learning-based measuring system for measuring a risk-indexing measurand essentially based on directly measured connected motor vehicle sensory data of a plurality of motor vehicles with associated telematics devices are achieved in that the telematics devices comprises one or more wireless connections to a data transmission network, and at least one interface for connection with at least one vehicle's data transmission bus and/or a plurality of interfaces for connection with sensors and/or measuring devices, wherein the telematics devices capture telematics data comprising vehicle features and usage parameter values and driver behavior parameter values and contextual and trip-related parameter values of the motor vehicle and/or driver, in that the system comprises a data pre-processing module identifying representative signals by filtering for relevant signals and a data exploration module for associating and interpreting the filtered signals in their context, and a dimensionality reduction module reducing the signals to signals having a significance in respect to the risk-indexing measurand indicative of a risk of the occurrence of an accident event having an impact to the vehicle and/or driver, and in that for the measuring of the risk-indexing measurand, the data pre-processing module and/or the data exploration module and/or the dimensionality reduction module are based on a set of machine-learning structures, transmitting their output values as input to a risk-score generator generating the risk-indexing measurand. The measuring of the risk-indexing measurand can e.g. be at least based on measuring the contribution given by (i) a vehicle component capturing which vehicle systems are present and activated or deactivated, (ii) a driver component at least capturing harsh maneuvers and/or excess of speed and/or risky behaviors and/or distraction, and (iii) a contextual component, the telematics data being enriched with additional data layers to capture location-based risks. The risk-indexing measurand capturing the risk of the occurrence of an accident event can e.g. provide a measure of riskiness of a driver driving a certain vehicle in a certain context in a certain way. The invention has, inter alia, e.g. the advantage it creates a unified electronic system based primarily on the data produced directly by the vehicle. These very punctual and rich data stem from a change in status of the vehicle at any point in time, due to i) the actions/reaction of the driver, ii) the context in which the driver is driving or, better, the way he perceives and feels the surroundings, iii) the way the car adapts to internal and external conditions, including the driver. The richness and reliability of these signals is leveraged to provide a comprehensive measuring and scoring system that covers different and complementary angles: (a) Vehicle component: which systems are present and activated/deactivated; (b) Driver component: harsh maneuvers, excess of speed, risky behaviors, distraction, etc.; (c) Contextual component: vehicle data are enriched with additional layers to evaluate location-based risks. These components are put together ab-initio by the system, namely at any point in time the system measures and/or creates a score that is measure for the riskiness of a driver, driving a certain vehicle in a certain context in a certain way. It should be noted that the term “riskiness”, as used herein, is understood as a physical measurand measuring the probability and/or likelihood of being involved in an occurring real-world accident event with a measurable impact strength (resulting in a measurable physical damage) to the vehicle. The inventive system relies on a set of advanced ML to identify representative signals (i.e., filter out what is not needed), disentangles components of value (i.e., a signal can be representative of a maneuver or set of maneuvers in a certain context) and combines only those components that can be insurance meaningful. That is, the system relies completely on technical electronic means and measuring devices/sensors allowing to put is measurands on physically measured quantities. The inventive system has further e.g. the advantage that it is enabled to combine signals which are representative of the vehicles (or another monitored object) performance/characteristics, of the behavior of the driver and context. The measuring data can come directly from measuring devices and/or sensors of the vehicle, from the mobile phone, from a cloud connected device (e.g. a connected vehicle) etc. Further, the inventive score-based measuring system can e.g. be realized as an edge-based solution with different electronic scoring modules e.g. embedded in the infotainment system of the vehicle (or another object), or on the mobile phone.

In an embodiment variant, the system can e.g. comprise a telematics aggregation engine capturing and aggregating the telematics data by a telematics-driven core aggregator with telematics data-driven triggers generating telematics data sets, wherein the capturing of the telematics data is triggered by detecting a change of a status of the vehicle at a point in time, the status being given by the values of the vehicle features and usage parameter and driver behavior parameter and contextual and trip-related parameter at said point in time, and wherein the change of the status is induced due to actions and/or reaction of the driver and/or due to the context in which the driver is driving and the way the driver perceives and feels the surroundings, respectively, and/or the way the vehicle adapts to internal and external conditions including the behavior of the driver. The aggregated telematics data sets can e.g. comprise a plurality of processed risk-related or risk-transfer-related (insurance) attributes, wherein the attribute values capturing characteristics of the vehicle driving by the driver having a significance in respect to the risk-indexing measurand indicative of a risk of the occurrence of an accident event having an impact to the vehicle and/or driver and/or characteristics having a significance in respect to a risk-transfer from the driver to a risk-transfer system.

In a further embodiment variant, further the risk-score generator can e.g. be based on one or more machine-learning structures for generating the risk-indexing measurand.

In another embodiment variant, the system comprises further a tariffmeter generating dynamically a variable tariff value for a risk-transfer from a certain driver to an automated risk-transfer system in respect to an aggregated risk exposure of transferred risks to said automated risk-transfer system from the vehicles. A driver's tariff value can e.g. be generated starting from the base tariff value by dynamically varying the base tariff value based on the measured vehicle features and usage parameter values and driver behavior parameter values and contextual and trip-related parameter values in respect to their measured frequency and severity at a certain time. The tariffmeter can e.g. comprise a tariff indicator dynamically indicating the present driver's tariff value at least indicating a not adjusted base tariff value and/or a slightly adjusted base tariff value and/or a reduced base tariff value and/or an increased base tariff value.

As an embodiment variant, the telematics devices can e.g. be connected to an on-board diagnostic system and/or an in-car interactive device and/or a monitoring cellular mobile node application.

In an embodiment variant, the machine-learning based system can e.g. comprise one or more risk-transfer systems to provide risk-transfers based on risk transfer parameters from at least some of the motor vehicles to the risk-transfer systems, wherein the risk-transfer systems comprise a plurality of payment transfer modules configured to receive and store monetary payment parameters associated with risk-transfer of risk exposures of said motor vehicles for pooling of their risks.

Finally, in an embodiment variant, the aggregated essentially directly measured connected motor vehicle sensory data of a plurality of motor vehicles can e.g. be enriched by sensory data of a mobile device of the driver, the mobile device at least comprising a smart phone or a cellular mobile phone associatable with the specific driver.

The inventive system and method have, inter alia, the advantage to provide a unified (“holistic”) risk real-time measuring and assessment structure as well as a real-time usage-based pricing structure by monitoring and processing sensory and operating data produced directly by the risk-exposed motor vehicle, such as a car, truck, motorcycle, electric bike, or the like. These typically very punctual and rich data stem from possible changes in status monitoring of the vehicle at any point in time, due to i) the actions/reaction of the driver, ii) the context in which the driver is driving or, better, the way he perceives and feels the surroundings, iii) the way the car adapts to internal and external conditions, including the driver. The invention leverages the richness and reliability of these signals to build a comprehensive scoring and measuring system that covers different and complementary angles: (i) vehicle component: which systems are present and activated/deactivated; (ii) driver component: harsh maneuvers, excess of speed, risky behaviors, distraction, etc.; and (iii) contextual component: vehicle data are enriched with additional layers to evaluate location-based risks. The above components are encompassed by the system ab-initio, namely at any point in time to create a score, i.e. a risk measure, that is representative of the riskiness of a driver, driving a certain vehicle in a certain context in a certain way (cf. FIG. 1). The core of the inventive solution relies on a set of advanced Machine Learning (ML) structures to identify representative signals (i.e., filter out what is not needed), disentangle components of value (i.e., a signal can be representative of a maneuver or set of maneuvers in a certain context) and combine only those components that can be insurance, i.e. risk-transfer, meaningful. In such a connected car approach, kinematic car data, ADAS usage data and contextual data are monitored by the system in real-time or near real-time providing a holistic risk score measure also in real-time (cf. FIG. 1-5). Thus, the inventive system allows to monitor and track relevant sensory data providing and measuring a risk score indexing measure in real-time.

### BRIEF DESCRIPTION OF THE DRAWINGS

The present invention will be explained in more detail below relying on examples and with reference to these drawings in which:

FIG. 1 shows a block diagram, schematically illustrating an exemplary technical risk-transfer framework according to the invention for real-time holistic motor scoring and real-time true vehicle driving risk measurements going technically beyond any traditional vehicle underwriting. The real-time measured risk-measurand can be mapped by an electronic pricing or tariff meter to appropriate real-time risk-transfer pricing or tariffs provided in monetary units.

FIG. 2 shows a block diagram, schematically illustrating exemplary real time kinematic vehicle measuring data of a connected car according to the inventive system.

FIG. 3 shows a block diagram, schematically illustrating exemplary real time ADAS usage measuring data of a connected car according to the inventive system.

FIG. 4 shows a block diagram, schematically illustrating exemplary real time contextual measuring data of a connected car according to the inventive system.

FIG. 5 shows a block diagram, schematically illustrating exemplary dynamic measurement and generation of the risk-indexing measurand 1051, i.e. the score-indexing parameter value over time.

FIG. 6 shows a block diagram, schematically illustrating exemplary real time holistic score measurand of a connected car according to the inventive system measured by the automated, fully integrated, and embedded measuring system for measuring a score-indexing parameter essentially based on directly measured connected motor vehicle sensory data and/or sensory data at the motor vehicle according to the invention. The measurements can be primarily based on measuring and sensory data produced directly by the vehicle. These very punctual and rich data stem from a change in status of the vehicle at any point in time, due to i) the actions/reaction of the driver, ii) the context in which the driver is driving or, better, the way he perceives and feels the surroundings, iii) the way the car adapts to internal and external conditions, including the driver. However, the measurements also can at least be partially based on measuring data of sensory devices of a mobile phone, in particular smart phone, as GPS sensors, accelerometers, gyroscopes etc. Regarding the vehicle sensory data, the present invention is able to holistically capture and rely on the full richness and reliability of these sensory signals which is leveraged to build the inventive comprehensive score measuring and metering system that covers different and complementary angles: (i) Vehicle components: which systems are present and activated/deactivated; (ii) Driver component: harsh maneuvers, excess of speed, risky behaviors, distraction, etc.; (iii) Contextual component: vehicle data are enriched with additional layers to real-time measure location-based risks, i.e. true probability measurands for the occurrence of an accident event at a certain location and point in time.

FIG. 7 shows a diagram schematically illustrating exemplary real-time telematics data capturing.

### DETAILED DESCRIPTION OF THE PREFERRED EMBODIMENTS

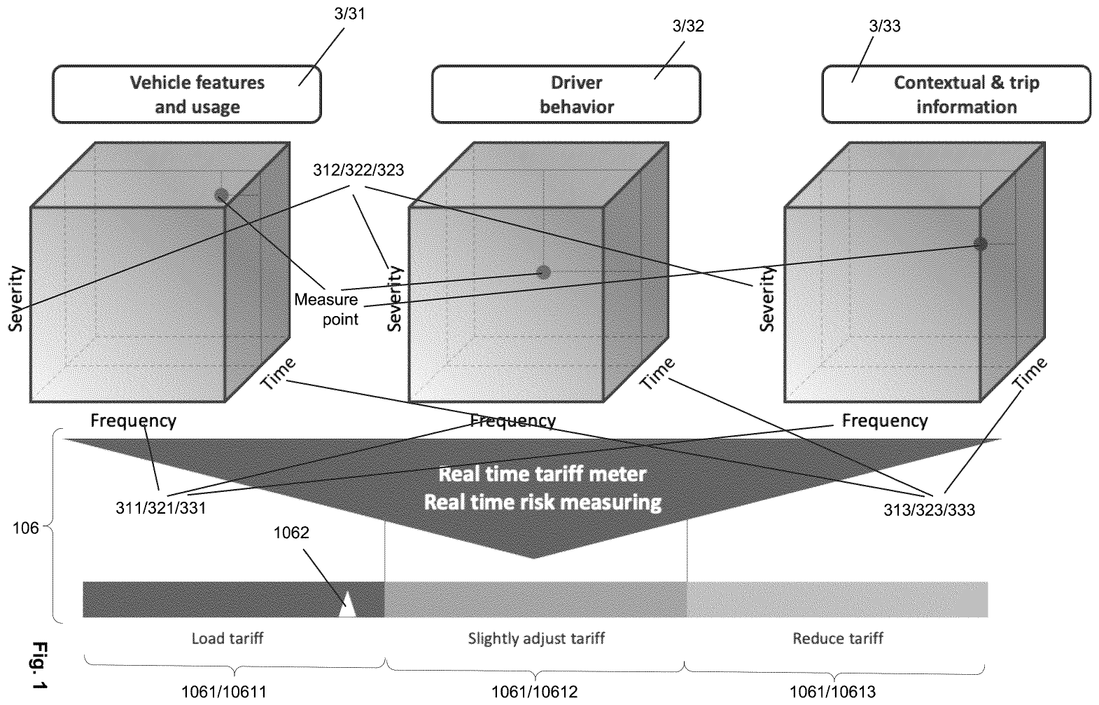

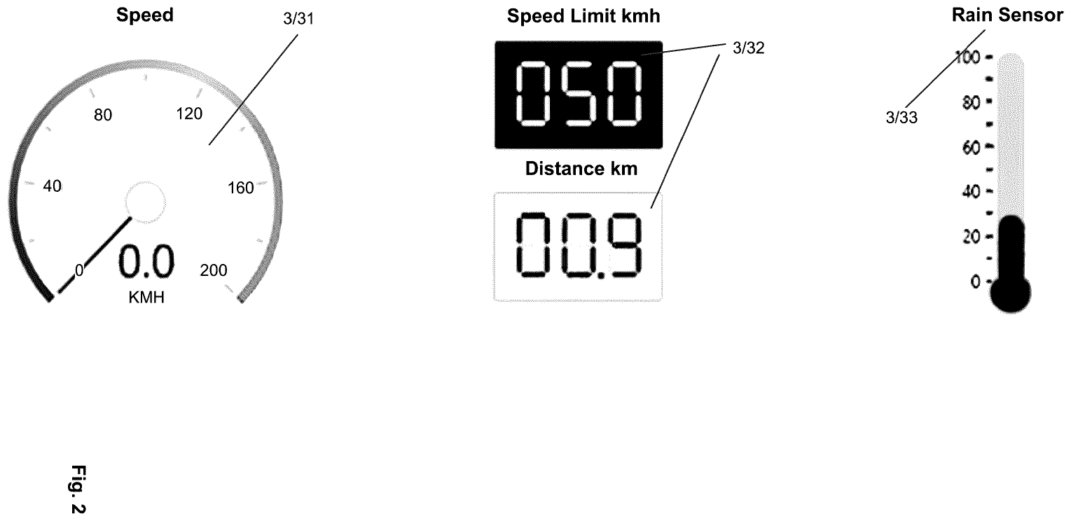

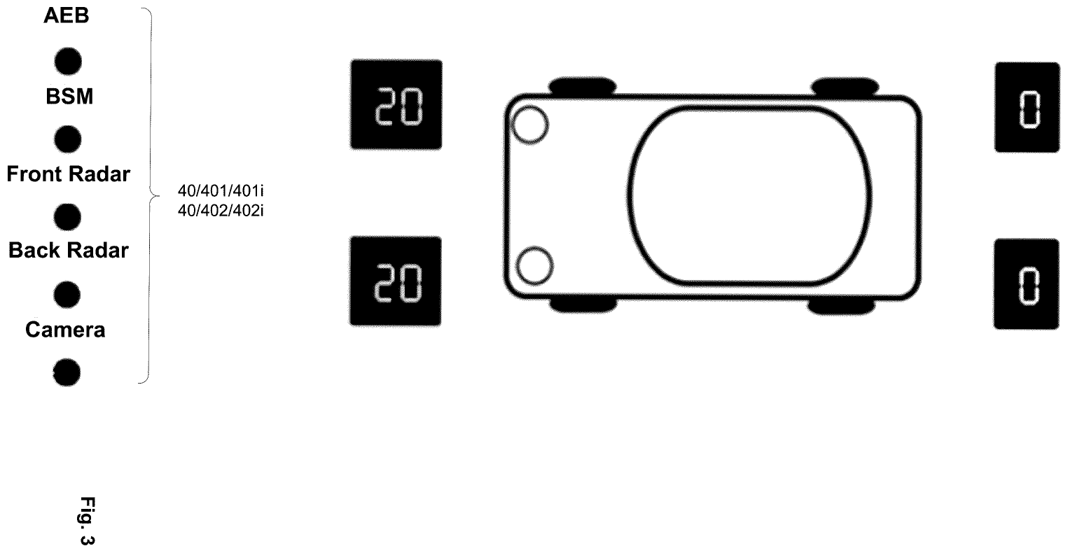

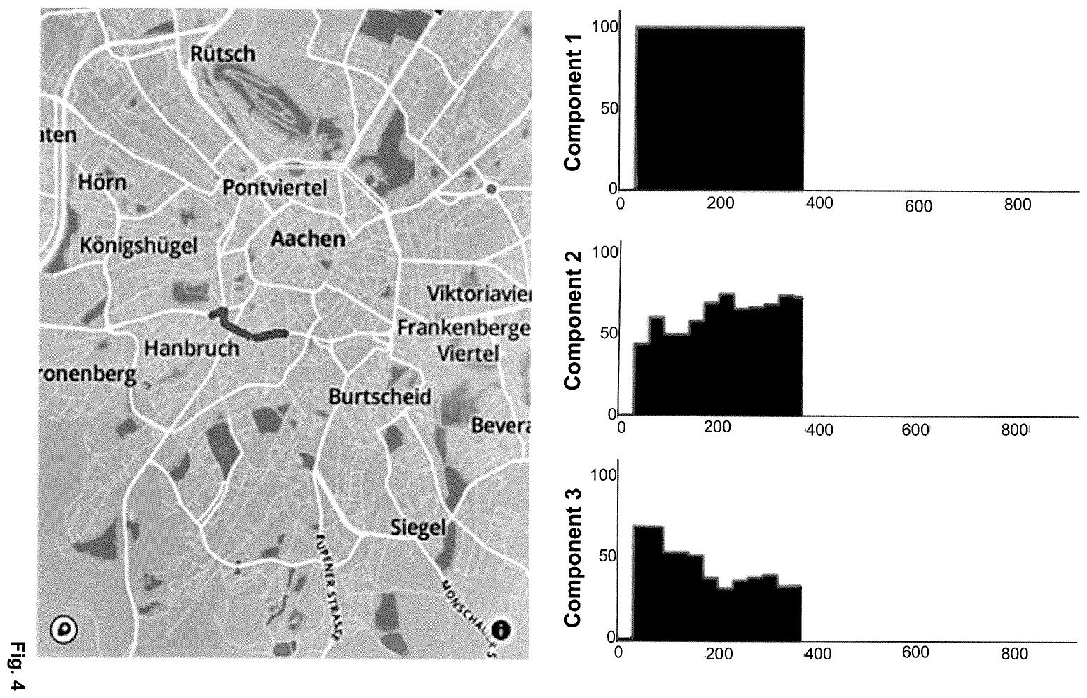

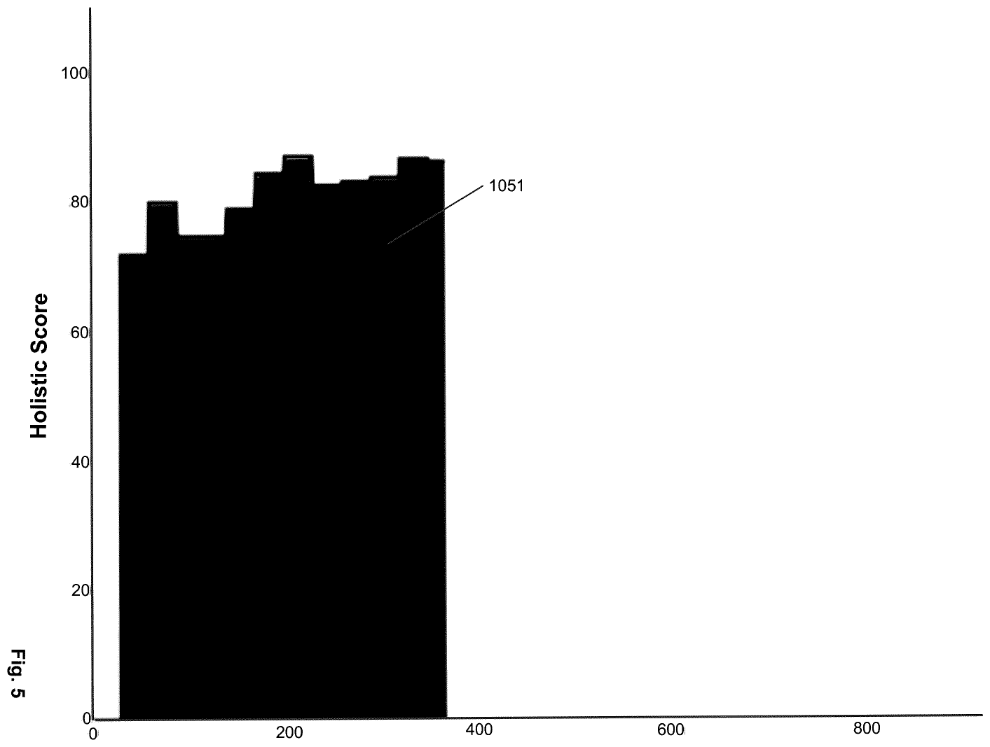

FIGS. 1 to 7 schematically illustrate an architecture for an automated, fully embedded, machine-learning-based measuring system 1 for measuring a risk-indexing measurand 1051 essentially based on directly measured connected motor vehicle sensory data of a plurality of motor vehicles 4 with associated telematics devices 45. The risk-indexing measurand capturing the risk of the occurrence of an accident event can e.g. provide a measure of riskiness of a driver 5 driving a certain vehicle 4 in a certain context in a certain way. That is, risk as accident risk is understood as a physical measurand of a measurable probability or likelihood value for the connected motor vehicle to being involved in an occurring real-world accident event having a physical impact as a measurable damage to the connected vehicle at a certain time, in a certain environment, and with a certain way of operation. Thus, the “riskiness” of a driver driving a certain vehicle 4 in a certain context in a certain way is also understood herein as a measurable physical quantity in respect to the measured probability value, the probability value range being indexed to allow a measurable scoring value, where the later also represent a physical quantity. The aggregated essentially directly measured connected motor vehicle sensory data of a plurality of motor vehicles 4 can e.g. be enriched by sensory data of a mobile device 452 of the driver 5, the mobile device 452 at least comprising a smart phone 4521 or a cellular mobile phone 4522 associatable with the specific driver 5.

The present invention provides a unified solution based primarily on the data produced directly by the vehicle. These very punctual and rich data stem from a change in status of the vehicle at any point in time, due to i) the actions/reaction of the driver, ii) the context in which the driver is driving or, better, the way he perceives and feels the surroundings, iii) the way the car adapts to internal and external conditions, including the driver. The richness and reliability of these signals is leveraged to build a comprehensive scoring measuring system that covers different and complementary angles, as FIG. 1 shows, at least comprising: (A) Vehicle component: which systems are present and activated/deactivated; (B) Driver component: harsh maneuvers, excess of speed, risky behaviors, distraction, etc.; and (C) Contextual component: vehicle data are enriched with additional layers to evaluate location-based risks.

As further illustrated by FIG. 1, these components are put together ab-initio, namely at any point in time to measure a score that is representative of the riskiness of a driver, driving a certain vehicle in a certain context in a certain way. It relies on a set of advanced ML to identify representative signals (i.e., filter out what is not needed), disentangle components of value (i.e., a signal can be representative of a maneuver or set of maneuvers in a certain context) and combine only those components that can be insurance meaningful.

The telematics devices 45 comprise one or more wireless connections 454/4541, . . . , 4546 to a data transmission network 2, and at least one interface 421 for connection with at least one vehicle's data transmission bus 42 and/or a plurality of interfaces for connection with sensors and/or measuring devices 40. The telematics devices 45 capture telematics data 3 comprising vehicle features and usage parameter values 31 and driver behavior parameter values 32 and contextual and trip-related parameter values 33 of the motor vehicle 4 and/or driver 5. The telematics devices 45 can e.g. be connected to an on-board diagnostic system 43 and/or an in-car interactive device 44 and/or a monitoring cellular mobile node application 4523.

The system 1 comprises a data pre-processing module 1013 identifying representative signals by filtering for relevant signals and a data exploration module 1014 for associating and interpreting the filtered signals in their context, and a dimensionality reduction module 1015 reducing the signals to signals having a significance in respect to the risk-indexing measurand indicative of a risk of the occurrence of an accident event having an impact to the vehicle 4 and/or driver 5. For the measuring of the risk-indexing measurand, the data pre-processing module 1013 and/or the data exploration module 1014 and/or the dimensionality reduction module 1015 are based on a set of machine-learning structures, transmitting their output values as input to a risk-score generator 105 generating the risk-indexing measurand 1051. The risk-score generator 105 can e.g. be based on one or more machine-learning structures for generating the risk-indexing measurand 1051.

The data pre-processing module 1013 provides data cleaning by removing noisy data and/or outliers from a measured dataset of the connected motor vehicle 4 as target dataset. The data pre-processing module 1013 can e.g. also comprises the data processing structure required to deal with possible inconsistencies in the target data. In case of discrepancies, specific variables will be transformed to enable data processing, detection, and triggering. The data gathered from the connected motor vehicles 4 are thus cleaned to treat missing values to make the data consistent with the subsequent data processing structures. The connected motor vehicles' data sets can e.g. comprise attributes with a certain amount of missing data. The data pre-processing module 1013 can e.g. monitor and automatically detect missing data structures and triggering the suitable imputation processing for the data set in question. In the present case, there can be different patterns of missing data, which can be detected by the data pre-processing module 1013 using threshold triggers and/or appropriate pattern recognition, e.g. detecting by appropriate training distribution characteristics of the missing data of the processed data set. The characteristics can e.g. comprise characteristics evolving from missing data at different thresholds, as missing completely at random (MCAR) and/or missing at random (MAR), and/or missing not at random (MNAR). The threshold triggers and/or pattern recognition processes can e.g. also be applied only at parts or sections of the data set processed. MCAR is the case when the pattern of the distribution of the missing values cannot be recognized to have any relationship between the observed data and the missing data. In other words, the missing values are like a random sample of all the cases in the feature. MAR requires for its detection/recognition that the missingness may be dependent on other observed variables, and/or their occurrence pattern, respectively, but independent of any unobserved features. In other words, missing values do not depend on the missing data, yet can be predicted using the observed data. MNAR detection, on the other hand, implies that the missing pattern relies on the unobserved variables; that is, the observed part of the data cannot explain the missing values. It is to note, that this missing data mechanism is one of the most difficult to treat by automated data processing as it renders the usual imputation methods meaningless.

The data pre-processing module 1013 can e.g. further comprise an exploratory data processing e.g. by an integrated classifier module providing univariate and bivariate analysis structures. The exploratory data processing allows to capture the different distributions that the features exhibit. On the other hand, for the bivariate analysis structure, the relationships between the different features and the response attribute, accident risk level, can be automated recognized and/or electronically captured. The parameter section of the univariate and bivariate analysis structures depends preferably on the extent to which the independent variables are capable of impacting the response variable significantly. This can be achieved e.g. by simple thresholding of the output values of the modules comprising the univariate and bivariate analysis structures in respect to the input variable values of said structure-executing modules.

The data pre-processing module 1013 can e.g. further comprise filter module for dimensionality reduction by reducing the number of variables to be used as input to the accident risk modelling structure. Such a filter module has the advantage that it provides more efficient modeling by more efficient data processing. The data processing within the filter module can e.g. be broadly divided into feature selection and feature extraction means. The feature selection process is involved in selecting the prominent variables, whereas the feature extraction is applied to transform the high dimensional data into fewer dimensions to be used in the modelling process. Thus, dimensionality reduction is used to train machine learning structures faster as well as technically increase modelling accuracy by reducing model overfitting and increasing processing efficiency by reducing the required CPU time.

In the present case, different techniques can e.g. be used to provide a feature selection structure based on filter structures, wrapper structures, and embedded processing structures. The filter structure can e.g. use a ranking to provide scores to each variable, either based on univariate statistical data processing or depending on the target variable. The rankings can then be assessed, e.g. by thresholding, to trigger whether to keep or discard the variable from the data processing. The wrapper structure, on the contrary, selects a subset of features and compares by pair-matching between different combinations of attributes to provide automated assigning scores to the features. The embedded structures are, for the present inventive system, more complicated to be realized, since the learning structure usually decides which features are best for a modelling structure while the model structure itself is being built. Attributes can be automatically selected based on Pearson's correlation, Chi-square, information gain ratio (IGR), and other techniques. In contrary, the feature extraction process derives new features from the original features, to increase the accuracy via eliminating redundant features and irrelevant features. For the present inventive system, two processes can be preferably applied (alone or together), i.e. a correlation-based feature selection and principal component analysis-based feature extraction.

Using the correlation-based feature selection, the system determines subsets of attributes based on the assumption that a useful subset of features contains highly correlated features with the class, yet uncorrelated to each other. This feature selection method can be efficiently and fast executed by the system. It removes noisy data and improves the performance of data processing structures. It does not require any limits on the selected number of attributes but generates the optimal number of features by itself. The correlation values for the feature selection are not only generated based on Pearson's correlation coefficient but are based on the measures namely, minimum description length (MDL), symmetrical uncertainty, and relief. CFS requires the nominal attributes in a data set to be discretized before generating the correlation. Nonetheless, for the present invention, it can be shown that it works on any data set, independent of the data transformation structures applied. For the present invention, it showed that CFS was more accurate compared to IGR. In fact, for some cases, the highest accuracy was obtained for the present classification problem using the CFS structure as compared to other feature selection structures.

The data pre-processing module 1013 can e.g. further comprise an unsupervised linear feature extraction structure (PCA) aimed at reducing the size of the data by extracting features having most information. PCA uses the features in the data set to create new features, referred herein as the principal components (PC). The principal components are then used as the new attributes to generate the prediction modelling structure. The principal components typically have better explaining power compared to the single attributes. The explaining power can be measured by a variance ratio of the principal components. This value shows how much information is retained by the combined features. PCA works by generating eigenvalues of a correlation matrix of the attributes, generated during data processing. The variance explained by each newly generated component is determined by the system and the components retained are those which describe the maximal variation in the data set. The proposed PCA structures showed to be useful (in respect to processing cycles and processing time) when used with the predictive modelling structures.

The compare the technical efficiency between applying correlation-based feature selection and principal components analysis feature extraction, the following can be noted for the present inventive system. The PCA structure generates new features by combining the existing ones to create better attributes, while correlation feature selection only selects the best attributes as they are, that is, without the generation of new ones, based on the predictive power. While the PCA structure does some feature engineering with the attributes in the data set, the resulting new features are more complicated to technically track them, as it is difficult to deduce meanings from the principal components. Applying the CFS structure, on the other hand, is relatively easier, as the original features are not combined or modified. For the inventive system, four machine learning algorithms are exemplarily implemented on CFS and PCA. Depending on the case, following the implementation of the structures, the accuracy measures be compared to measure the effectiveness of the applied feature reduction.

Different supervised machine learning structures can e.g. be implemented on the data set to build the predictive modelling structures, namely, Multiple Linear Regression, REPTree, Random Tree, and Multilayer Perceptron. However, other supervised learning structures are also imaginable.

Multiple linear regression shows the relationship between the response variable and at least two predictor variables by fitting a linear relation to the observed data points. In other words, the parameter relation is used to predict the response variable based on the values of the explanatory variables collectively. The efficiency of an applied structure, e.g. a multiple linear regression structure, can e.g. be measured based on the sum of squared errors which shows the average distance of the predicted data points to the observed data values. The model parameter values can e.g. be generated to minimize the sum of squared errors, such that the accuracy of the modelling structure is increased. The variables significance in the regression relation can e.g. be determined by applying statistical relations and are mostly based on the collinearity and partial correlation statistics of the explanatory features.

Another option is applying a REPTree classifier which a type of decision tree classification structure. It can generate both classification and regression trees, depending on the type of the response variable. Presently, a decision tree can e.g. be generated in case of discrete response attribute, while a regression tree can be developed if the response attribute is continuous. For the inventive system, decision trees can be a useful machine learning structure to solve the above discussed classification problems. A decision tree structure can be generated comprising of a root node, branches, and leaf nodes aimed at representing data in the form of a tree-like graph. Each internal node represents the tests performed, and the branches are representative of the outcome of the test. The leaf nodes, on the other hand, represent class labels. Decision trees mainly use a divide and conquer processing structure for prediction purposes which makes decision trees a good machine learning structure for the present machine-based prediction. As another technical possibility to realize the prediction engine with the prediction modelling structure, REPTree machine learning structures can e.g. be applied, where REPTree is also denoted as Reduced Error Pruning Tree. The REPTree structure makes use of regression tree logic to generate numerous trees in different data processing iterations. For the realization of the present inventive system, this machine-learning structure showed to be a fast and efficient learner, which generates decision trees based on the information gain and variance reduction. After generating several trees, the structure automatically chooses and selects the best tree using the lowest mean-square-error measure when pruning the trees.

Finally, also a Random Tree can e.g. be applied as a decision tree structure, however, its application is for the present case different from the previously discussed REPTree structure. Random Tree as a machine learning structure accounts for k randomly selected attributes at each node in the decision tree. Thus, the random tree classifier builds a decision tree based on random selection of data as well as by randomly choosing attributes in the data set. Unlike REPTree classifier, this structure performs no pruning of the tree. The structure works in a way that it conducts backfitting, which means that it generates estimation of class probabilities based on a hold-out set. In the present case, the random tree classifier can also be used e.g. together with CFS which can be shown to work efficiently with large data sets. Further, the use of random trees showed to achieve high levels of modelling accuracy by modifying the parameters of the random tree classifier.

In addition, missing data imputation can e.g. be applied. If the data are assumed to be MAR, the multiple imputation showed to be an appropriate technique to replace the missing values in the features. Multiple imputation is statistical-based and uses available data to predict missing values. The proposed multiple imputation involves three steps, namely, imputation, analysis, and pooling. The proposed multiple imputation is more reliable than single imputation, such as mean or median imputation as it considers the uncertainty in missing values. The steps for multiple imputation comprise: (i) Imputation: This step performs the imputation of the missing values several times depending on the number of imputations stated. The step results in a number of complete data sets. The imputation can e.g. be realized using by a predictive model structure, such as linear regression to replace missing values by predicted ones based on the other variables present in the data set; (ii) Analysis: The various complete data sets formed are automatically processed. Parameter estimates and standard errors are generated and outputted; and (iii) Pooling: The output results are then integrated together to form a final result output. The MICE (Multivariate Imputation via Chained Equations) structure in R can e.g. be utilized to do the multiple imputations. The missing data were assumed to be MAR. The categorical variables were removed and only numeric attributes were used to do the imputation.

It is to be noted that the present inventive system has significant advantages over the prior art systems. For the automated prediction of accident risk and probability values, the proposed predictive modeling using machine-learning structure can provide the notable difference in the way which automated prediction can be provided as compared to the traditional methods in respect to accuracy of the measured predictive values and processing efficiency. Previously, accident risk predictions were typically conducted using complex actuarial formulas and usually was a very lengthy process. Now, with the present completely automated measuring and data processing solution, the problem can be solved on a complete technical basis, where the technical solution is realized on a highly optimized processing structure providing more accurate, more precise, and more efficient forecast output values. Therefore, it would enhance the technical fields by technically allowing faster, more accurate and more efficient data measuring and processing based on a completely technical solution based on automatically measured and processed sensory data of connected motor vehicles 4.

The measuring of the risk-indexing measurand can e.g. be at least based on measuring the contribution given by (i) a vehicle component capturing which vehicle systems are present and activated or deactivated, (ii) a driver component at least capturing harsh maneuvers and/or excess of speed and/or risky behaviors and/or distraction, and (iii) a contextual component, the telematics data 3 being enriched with additional data layers to capture location-based risks.

The system 1 can e.g. comprise a telematics aggregation engine 101 capturing and aggregating the telematics data 3 by a telematics-driven core aggregator 1011 with telematics data-driven triggers 1012 generating telematics data sets 34. The capturing of the telematics data 3 is triggered by detecting a change of a status of the vehicle 4 at a point in time. The status is given by the values of the vehicle features and usage parameter 31 and driver behavior parameter 32 and contextual and trip-related parameter 33 at said point in time. The change of the status is induced due to actions and/or reaction of the driver and/or due to the context in which the driver 5 is driving and the way the driver 5 perceives and feels the surroundings, respectively, and/or the way the vehicle 4 adapts to internal and external conditions including the behavior of the driver 5.

The aggregated telematics data sets 34 can e.g. comprise a plurality of processed risk-related or risk-transfer-related insurance attributes, wherein the attribute values capturing characteristics of the vehicle driving by the driver 5 having a significance in respect to the risk-indexing measurand indicative of a risk of the occurrence of an accident event having an impact to the vehicle 4 and/or driver 5 and/or characteristics having a significance in respect to a risk-transfer from the driver 5 to a risk-transfer system 6. Thus, the machine-learning based system 1 can e.g. comprise one or more risk-transfer systems 6 to provide risk-transfers 621 based on risk transfer parameters 6421 from at least some of the motor vehicles 4 to the risk-transfer systems 6, wherein the risk-transfer systems 6 comprise a plurality of payment transfer modules 63 configured to receive and store monetary payment parameters 6422 associated with risk-transfer of risk exposures 64 of said motor vehicles 4 for pooling of their risks 64.

The system 1 can e.g. comprise further a tariffmeter 106 generating dynamically a variable tariff value 1061 for a risk-transfer from a certain driver 5 to an automated risk-transfer system 6 in respect to an aggregated risk exposure 64 of transferred risks to said automated risk-transfer system 6 from the vehicles 4. A driver's tariff value 1061 can e.g. be generated starting from the base tariff value 10611 by dynamically varying the base tariff value 10611 based on the measured vehicle features and usage parameter values 3/31 and driver behavior parameter values 3/32 and contextual and trip-related parameter values 33 in respect to their measured frequency 311/321/331 and severity 312/322/332 at a certain time 313/323/333. The tariffmeter 106 can e.g. comprise a tariff indicator 1062 dynamically indicating the present driver's tariff value 1061 at least indicating a not adjusted base tariff value 10611 and/or a slightly adjusted base tariff value 10612 and/or a reduced base tariff value 10613 and/or an increased base tariff value 10614.

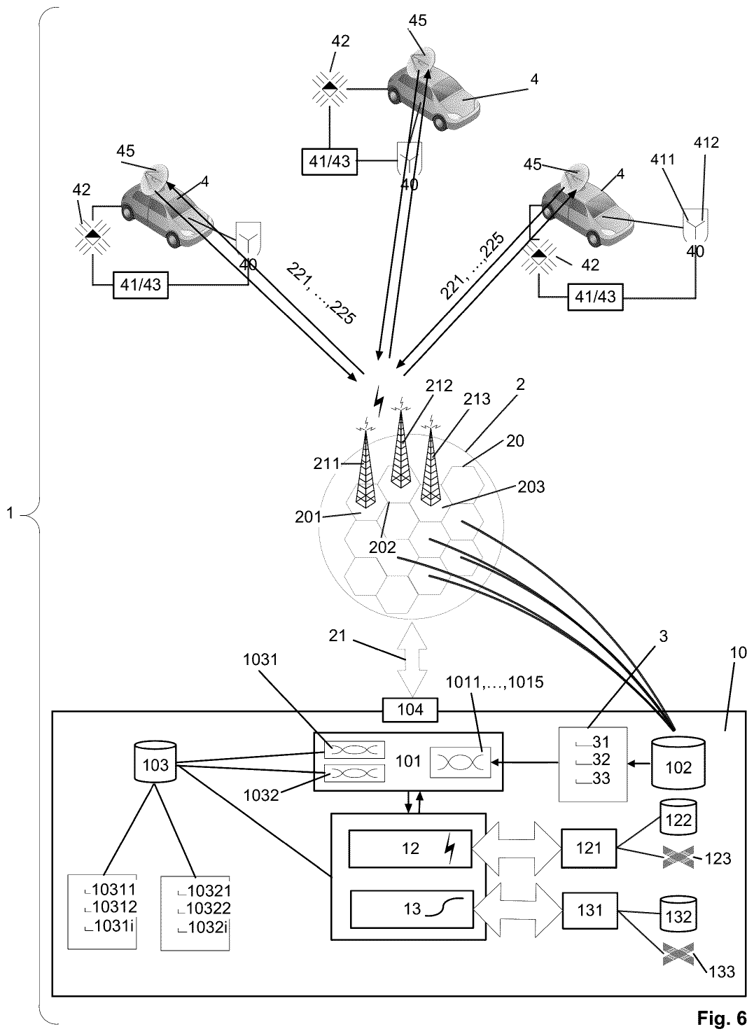

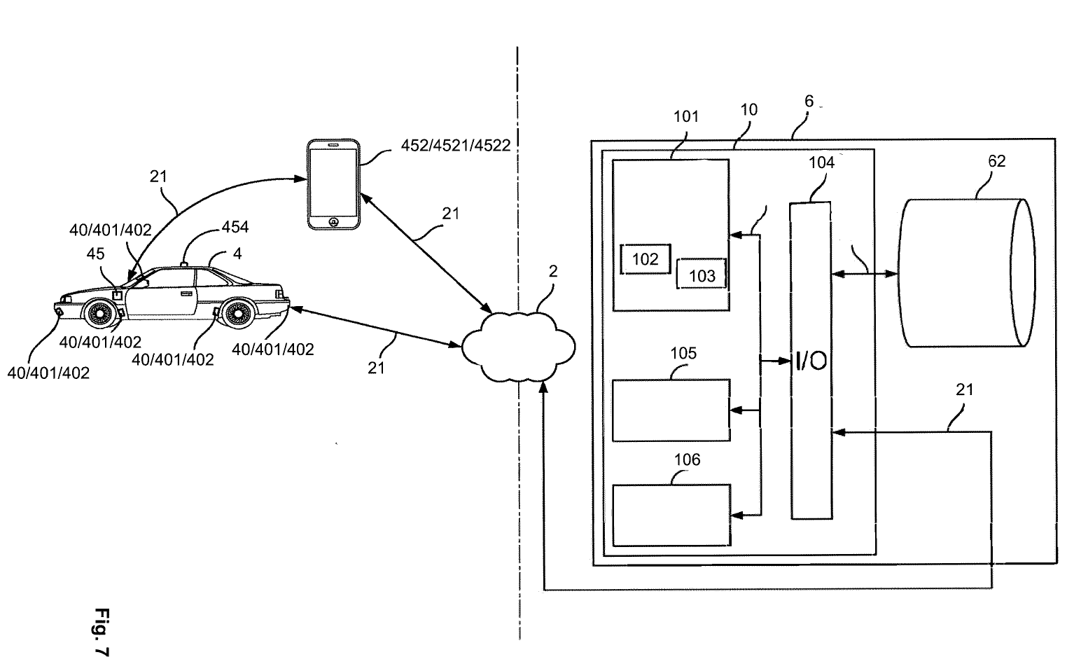

FIG. 6 illustrates a block diagram of an interconnected wireless communication system 100 on which the methods described herein may be implemented. The communication system may generally be divided into front-end components and back-end components, both of which may include hardware and software applications, as well as various data communications channels for communicating data between the various hardware and software components. The front-end components may generate or collect real-time or near real-time and historical and/or statistical route and/or traffic data, in particular sensory data from mobile device-mounted sensors, vehicle-mounted sensors, smart infrastructure-mounted sensors, wearable electronics-mounted sensors, or other sensors. It is understood that by “near real-time,” it is meant data that is representative of events occurring within approximately the last five minutes. Accordingly, in some examples, near real-time route data may be indicative of events occurring instantaneously or near-instantaneously within capabilities of computer processors, and in other examples, near real-time route data may be indicative of events that have occurred within approximately the last five minutes. Other examples of suitable timeframes are possible.

The real-time or near real-time and historical data may be in the form of vehicle data, vehicle collision data, geographic location data (e.g., GPS data), telematics data, mobile device data, vehicle-mounted sensor data, auto insurance claim data, autonomous vehicle data, smart infrastructure sensor data, image data, or other data. The real-time and historical data may provide contextual information of the vehicle 108 (e.g., a car, truck, motorcycle, bicycle), pedestrian, bicyclist, skier and the likes, related to traffic, vehicle damage, extent of injuries at a vehicle collision, number and identification of vehicles involved, dates and times of vehicle use, duration of vehicle use, mobile device GPS location, vehicle GPS location, speed, RPM or other tachometer readings of the vehicle, lateral and longitudinal acceleration of the vehicle, environment (e.g., construction, accidents in the area, weather, road condition), or other information relating to use of the vehicle 4. Real-time and/or historical data, in particular route or location related data, may be collected before, during, and/or after vehicle collisions. The near real-time and traffic data can also provide contextual information of the vehicle 4, pedestrian, bicyclist, and the likes, related to traffic levels, accidents, road engineering occurrences (e.g., road or roadway construction, lane blockages or obstructions, and the like) on a route or location. As previously noted, the near real-time data can e.g. be combined with historical data, in particular historic sensory and measuring data.

Front-end components may include on-board computer as part of the telematics 45, mobile device 452 (e.g., a smart phone, a cellular phone, a tablet computer, a special purpose or general use computing device, smart watch, wearable electronics such as augmented reality appliance, vehicle navigation device, dedicated vehicle monitoring or control device, and the likes), one or more sensors 40 associated with vehicle 4, and a communication component. The on-board computer may be a general-use on-board computer capable of performing any number of functions relating to vehicle operation or a dedicated computer for autonomous vehicle operation. Further, the on-board computer 45 may be originally installed by the manufacturer of the vehicle 4 or installed as an aftermarket modification or addition to the vehicle 4. Examples of sensors 40 include a GPS unit 4012, a digital camera 4016, a video camera 4016, a LIDAR sensor 4015, an ultra-sonic sensor 4013, an infrared sensor 4018, an ignition sensor, an odometer 4014, a system clock, a speedometer 4022, a tachometer 4022, an accelerometer, a gyroscope, a compass, a geolocation unit, radar unit 4017, and an inductance sensor. Some of the sensors 40 (e.g., radar, LIDAR, or camera units) may actively or passively scan the vehicle environment for obstacles (e.g., other vehicles, buildings, pedestrians, etc.), roadways, lane markings, signs, or signals. Other sensors 40 (e.g., GPS, accelerometer, or tachometer units) may provide data for determining the location or movement of the vehicle 4. Other sensors 40 may be directed to the interior or passenger compartment of the vehicle 108, such as cameras, microphones, pressure sensors, thermometers, or similar sensors to monitor the vehicle operator and/or passengers within the vehicle 4. The sensors 40 may also be removably or fixedly incorporated within or connected to the on-board computer and/or telematics 45 or the mobile device 452 and may be disposed in various arrangements.

In some embodiments, the telematics devices 45 or mobile device 452 may each be configured to execute one or more algorithms, programs, or applications to generate, collect, or analyze various types of real-time or near real-time and historical data from one or more sensors 40 mounted or installed within the vehicle 4. For instance, if vehicle 4 is an autonomous vehicle, the on-board computer and/or telematic devices 45 may collect data related to the autonomous features to assist the vehicle operator in operating the vehicle 4. The on-board computer 45 or mobile device 452 may further process the near real-time and historical data to calculate a risk index measure for an area. In such embodiments, the on-board computer 45 or mobile device 452 may process the near real-time and historical data to present, determine, and/or select a travel route for a vehicle based upon the different risk score index, and may further generate a virtual navigation map or an alert depicting the area to display on the mobile device 452 or on-board computer 45 or take other actions. In some embodiments, the mobile device 452 may supplement the functions performed by the on-board computer 45. In other embodiments, the on-board computer 45 may perform all of the functions of the mobile device 452, in which case no mobile device 452 may be present in the system 1. Additionally, the mobile device 452 and on-board computer may communicate with one another directly over link 21 or indirectly over multiple radio links.

The on-board computer 45 or mobile device 452 may also be configured to communicate with the vehicle 4, in particular via a wireless connection, utilizing a Bluetooth communication protocol, for instance. In some embodiments, the on-board computer 45 or mobile device 452 may communicate with vehicle 4, such as via a vehicle controller, or a vehicle telephony, entertainment, navigation, or information system of the vehicle 108 that provides functionality other than autonomous (or semi-autonomous) vehicle control. The communication component may be utilized to transmit and receive information from external sources, including other vehicles, infrastructure, smart home controllers or sensors, or the back-end components. To send and receive information, the communication component may include a transmitter and a receiver (or transceiver) designed to operate according to predetermined specifications, such as the dedicated short-range communication (DSRC) channel, wireless telephony, Wi-Fi, or other existing or later-developed communications protocols. The received information may supplement the data received from the sensors 40. For example, the communication component may receive information that another vehicle ahead of the vehicle 4 is reducing speed, allowing for adjustments in the operation of the vehicle 4.

In some embodiments, the front-end components may communicate with the back-end components. As such, the back-end components may receive real-time or near real-time and historical and/or statistical data, e.g. also route or location related data, that was collected by the front-end components. The on-board computer 45 and/or mobile device 452 may be configured to send near real-time and historical data to and/or receive data over the network 2 using one or more suitable communication protocols, such as a Wi-Fi direct protocol, an ad-hoc cellular communication protocol, and the likes. Network 2 may be a proprietary network, a secure public internet, a virtual private network, or some other type of network, such as dedicated access lines, plain ordinary telephone lines, satellite links, cellular data net-works, or a combination thereof. Network 2 may be implemented as a wireless telephony network (e.g., GSM, 20 CDMA, LIE, etc.), a Wi-Fi network (e.g., via one or more IEEE 802.11 Standards), a WiMAX network, a Bluetooth network, and the likes. The network 2 may include one or more radio frequency communication links, such as wireless communication links 21 with the mobile device 452 and on-board computer 45, respectively. Where the network 2 comprises the Internet, data communications may take place over the network 2 via an Internet communication protocol.

In further embodiments, the front-end components may include an infrastructure communication device for monitoring the status of one or more infrastructure components. Infrastructure components may include roadways, bridges, traffic signals, gates, switches, crossings, parking lots or garages, toll booths, docks, hangars, or other similar physical portions of a transportation system's infra-structure. Further, the infrastructure components may be temporary fixtures or components such as road construction signs or vehicles, emergency vehicles, and the likes. The infrastructure communication device may include or be communicatively connected to one or more sensors (not shown) for detecting and receiving information relating to the condition of the infrastructure component, such as weather conditions, traffic conditions, or operating conditions of the infrastructure component. The infrastructure communication device may further be configured to communicate the received information to vehicle 4 via the communication component. In some embodiments, the infrastructure communication device may receive information from the vehicle 4, while, in other embodiments, the infrastructure communication device may only transmit information to the vehicle 4. The infrastructure communication device may be configured to monitor the vehicle 4 and/or directly or indirectly communicate information to other vehicles.

The automotive system 10 may receive or collect near real-time and historical measuring or sensory data from the front-end components via the network 2, store the received near real-time and historical data in database 102/103, process the received near real-time and historical data (e.g., generate the risk indexing score measure based upon the near real-time and/or historical data), and/or communicate information associated with the received or processed near real-time and historical route data back to the front-end components. Further, the automotive system 10 may access data stored in database 102/103 when classifying or identifying high risk or hazardous areas, execute various functions and tasks associated with generating the unified risk score measure or e.g. a virtual navigation map depicting the hazardous area or alerts of approaching hazardous areas.

The automotive system 10 may comprise a controller that is operatively connected to the database 102/103 via a link. The controller may also be operatively connected to the network 2 via a link 21. The controller may include a program memory, a processor, a random-access memory (RAM), and an input/output (1/O) circuit, all of which may be interconnected via an address/data bus. Similarly, the memory of the controller may include multiple RAMs and multiple program memories. The RAM and program memory may be implemented as semiconductor memories, magnetically readable memories, or optically readable memories, for example. The program memory may store various software applications, which may include a risk index mapping application and a travel route determination application. The risk index mapping application may determine and electronically map an area having a risk index onto a virtual map or an alert. The travel route determination application may determine and select travel routes based on a predicted unified risk score index measure that route a vehicle, pedestrian, or bicycle from a starting location to a destination that avoids traversing an area having a higher risk index. As such, both the risk index mapping application and travel route determination application may have access to the risk score generated by processor. The various software applications may be executed by the same computer processor or by different computer processors.

In some embodiments, one or more portions of the automotive system 10 may be implemented as one or more storage devices that are physically co-located with the system 1, or as one or more storage devices utilizing different storage locations as a shared database structure (e.g. cloud storage). In some embodiments, the automotive system 10 may be configured to perform any suitable portion of the processing functions remotely that have been outsourced by mobile device 452 or the on-board computer 45. For example, mobile device 452 may collect near real-time and historical data as described herein but may send the real-time, near real-time and/or historical data to the automotive system 10 for remote processing by the automotive system 10 instead of processing the near real-time and historical data locally. In such embodiments, the automotive system 10 may receive and process the near real-time and historical data to determine or select a travel route for a vehicle based upon the risk score and may generate a related risk-score pricing for the intended vehicle-use or route.

Although the system 1 is shown to include one vehicle 4, one mobile device 452, one on-board computer or telematics 45, and the automotive system 10, it should be understood that additional vehicles 4, mobile devices 452, on-board computers 45 and/or automotive systems 10 may be utilized. For example, the system 1 may include a plurality of automotive systems 10 and hundreds of mobile devices 452 or on-board computers 45, all of which may be interconnected via the network 20. For example the automotive system 10 may be dedicated for each of the various types of near real-time and historical data described above. Furthermore, the database storage or processing performed by the one or more automotive system 10 may be distributed among a plurality of automotive system 10 in a cloud computing arrangement. This configuration may provide various advantages, such as enabling near real-time uploads and downloads of information, as well as periodic uploads and downloads of information. This may in turn support a thin-client embodiment of the mobile device 452 or on-board computer 45 discussed herein.

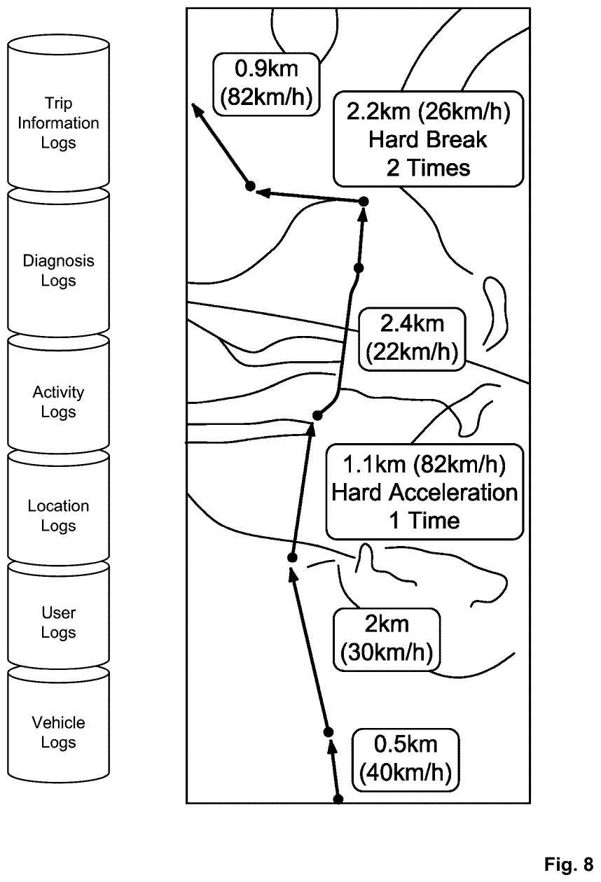

FIG. 7 illustrates a block diagram of a system 1 including mobile device 452 or an on-board computer 45 and an automotive system 10 consistent with the system 1 of FIG. 6. The mobile device 452 or on-board computer 45 may include a display, a controller, a GPS unit, a communication unit, an accelerometer, a sensor array (e.g., one or more cameras, accelerometers, gyroscopes, magnetometers, barometers, thermometers, proximity sensors, light sensors, Hall Effect sensors, radar units) and one or more user-input devices, such as a keyboard, mouse, microphone, or any other suitable user-input device. The communication unit may provide input signals to the controller via the I/O circuit, and may also transmit sensor data, device status information, control signals, or other output from the controller to one or more external sensors within the vehicle 4 or automotive system 10. The one or more sensors of the sensor array may be positioned to determine telematics data regarding the speed, force, heading, and/or direction associated with movements of the vehicle 4. In some embodiments, the mobile device 452 or on-board computer 45 may be integrated into a single device, and in other embodiments, may be separate devices.

Similar to the controller of FIG. 6, the controller of FIG. 7 may include a program memory, one or more processors 10 (e.g., microcontrollers or microprocessors), a RAM 212, and the I/O circuit, all of which are interconnected via an address/data bus 214. The program memory may include an operating system, a data storage, a plurality of software applications, and/or a plurality of software routines. The operating system, for example, may include one of a plurality of general purpose or mobile platforms, such as the Android, iOS, or Windows operating systems. Alternatively, the operating system may be a custom operating system designed for vehicle operation using the on-board computer 45. The data storage 102/103 may include data such as user profiles and preferences, application data for the plurality of applications, routine data for the plurality of routines, and other data related to road navigation and/or vehicle operation features. In some embodiments, the controller may also include, or otherwise be communicatively connected to, other data storage mechanisms, such as hard disk drives, optical storage drives, or solid state storage devices located within the vehicle 4.

As discussed with reference to the controller, it should be appreciated that although FIG. 7 depicts only one processor, the controller may include multiple processors. Processor may be configured to execute any of one or more of the plurality of software applications or any one or more of the plurality of software routines residing in the program memory, in addition to other software applications. Similarly, the controller may include multiple RAMs and multiple program memories 102/103. RAM and program memory 102/103 may be semiconductor memories, magnetically readable memories, or optically readable memories, for example.

As discussed with reference to the program memory, data storage 102/103 may store various software applications implemented as machine-readable instructions, which may include a risk measure mapping application, a travel route determination application, a risk score indexing application, and a risk-transfer pricing application based on the measured risk score index measure. The risk measure/risk index mapping application may determine and electronically map an area having a particular risk index onto a virtual navigation map. The travel route determination application may determine and select travel routes that route a vehicle, pedestrian, or bicycle from a starting location to a destination that avoids traversing an area having a risk score index measure value. The various software applications may be executed by the same computer processor or by different computer processors. The various software applications may call various software routines to execute the various software applications.

In addition to applications and routines, the data storage 102/103 may store various data, such as expected collisions data, observed collisions data, risk index data, travel route or location data, and/or notification data. In one embodiment, the data storage 102/103 may include one or more of real-time, near real-time and historical data and/or pricing or claims data. In other embodiments, near real-time and historical data and/or claims data may be stored in database 102/103 managed by the automotive system 10.

Expected collisions data may represents an expected number of collisions. The expected collisions data may include data representing a number of collisions that may be expected for any one or more of the following: a particular area of traffic (e.g., an intersection, street, portion of a street, parking lot, and the likes), a particular time, such as the time of year (e.g., a particular date, month, and/or season), a day of the week (e.g., Sunday-Saturday), a time of day (e.g., a particular time or a general time, such as “evening” or “morning”), a volume of traffic (e.g., a number of cars per hour), and the likes. In some embodiments, the processor generates or collects some or all of the expected collisions data based upon the historical traffic data, the real-time or near real-time data, and/or the pricing or claims data or other data that are gathered from various sources, such as vehicle 4, sensors 40, and the automotive system 10.

For example, claims data may be associated with actual insurance claims arising from real world vehicle collisions, such as data scrubbed of personal information, or otherwise de-identified auto insurance claim data. Claims data generally represents insurance claims filed by insurance policy owners. The claims data may identify a particular collision, policy owners, involved vehicles, a location where the collision occurred, property involved, repair and/or replacement costs and/or estimates, a time and date of the collision, and/or various other information. In one embodiment, actual claim images (such as mobile device images of damaged vehicles, or images acquired via vehicle-mounted cameras and/or sensors) may be analyzed to associate an amount of physical damage shown in one or more images of vehicles involved in a vehicle collision with a repair or replacement cost of the vehicles. The actual claim images may be used to estimate repair or replacement cost for vehicles involved in past, recent, or current vehicle collisions. The automotive system 10 may then analyze the historical traffic data, the near real-time route data, and/or the claims data to calculate a risk index for a particular area or location of traffic or route.

The automotive system 10 may acquire historical traffic data, real-time sensory and/or route data, near real-time sensory or route data, and/or the claims data for a number of comparable areas near a potentially hazardous area of interest. For each comparable area, the acquired historical traffic data may include a number of collisions for a particular time period and/or a traffic volume. The automotive system 10 may generate a “per vehicle” collision rate for each comparable area and may rely on an average of these “per vehicle” collision rates to estimate the expected number of collisions for the potentially hazardous area of interest (e.g., based upon the expected traffic volume of the area of interest). Accordingly, the automotive system 10 may generate expected collisions for a particular area and store the calculated expected collisions to the data storage 102/103 as expected collision data.

The automotive system 10 may then receive data identifying observed collisions from the system 1 for the same area in which expected collisions were generated. For example, in some embodiments, the automotive system 10 may transmit a query to the system managing the claims database in order to receive data identifying observed collisions from the automotive system 10. The automotive system 10 may identify from the claims data collisions that occurred within the area of interest and within the particular time period. The number of identified collisions resulting from the query may be saved to the data storage 102/103 as observed collision data. Observed collisions data may identify a total number of collisions that actually occurred at a certain area. Observed collisions data may be indicative of collisions involving policy holders associated with a particular insurance company or may also be indicative of collisions involving policy holders and/or vehicles associated with multiple companies.

For each comparable area, the acquired real-time or near real-time sensory and/or route data may include a number of real-time or near real-time incidents or events that may impact how risky the location or route is (also cf. FIG. 8). Examples of potential events that may impact the unified risk score include accidents, increased or decreased traffic, and road engineering occurrences (e.g., construction, lane blockages, and the like) on a specific route. The near real-time data only pertains to events which are presently impacting a route or location or have impacted the route or location within the past ten minutes from when the automotive system 10 acquired the real-time or near real-time data. The near real-time location or route data may be indicative of the occurrence of the event, or alternatively or additionally, the near real-time data may include quantitative data regarding the occurrence or event such as an anticipated delay time. Accordingly, the automotive system 10 may receive and use the real-time or near real-time data from the telematics 45 to generate an expected delay for a particular area and store the calculated expected delay to the data storage 102/103 as expected delay data. For example, in some embodiments, the automotive system 10 may periodically transmit a query to the telematics 45 in order to receive the near real-time route data within the area of interest and within the particular time period.

The automotive system 10 may next compare the expected collisions, the observed collisions, and the number of present occurrences or events to generate the risk index to measure the riskiness of an area or areas. For example, in some embodiments, the automotive system 10 may divide the number of observed collisions by the number of expected collisions and multiply the number of present occurrences to the resulting quotient. The automotive system 10 may store the resulting value to the data storage 102/103 as risk index data for the particular area. In such embodiments, a risk index value equal to one may suggest that an area is about as dangerous as expected; a risk index value greater than one may suggest that the area is riskier than expected; and a risk index value less than one may suggest that the area is less risky than expected. Accordingly, the risk measure data represents one or more risk measures generated by the automotive system 10 after comparing the expected collisions to the observed collisions and current events to generate the risk measure.

However, the risk measure may also be generated differently. For example, the automotive system 10 may subtract the observed collisions from the expected collisions and may store the result as risk measure or risk index data. In this case, a value of 0 may suggest that an area is about as risky as expected; a positive value may suggest that an area is less risky than expected, and a negative value may suggest that the area is riskier than expected. The present occurrence data may be appended to the calculated difference to impact the generation. In some examples, the risk measure may be separately generated and presented from the present occurrence data. For example, the risk measure may be generated solely based on the observed collisions and the expected collisions, and this risk index may be presented to a user to illustrate how risky the route is. The present occurrence data may be provided as a separate value so the driver 5 may determine whether the route presently is too risky for traversal. Other examples are also possible. The automotive system 10 can e.g. also (i) collect historical traffic data, real-time or near real-time route data, and/or auto pricing and/or claim data via wireless communication or data transmission over one or more radio links or wireless communication channels; (ii) determine hazardous routes or locations from the historical traffic data, near real-time route data, and/or auto claim data; and (iii) generate a notification, such as a virtual alert or navigation map, of the possible routes.

### LIST OF REFERENCES

1 Automated, embedded, machine-learning-based measuring system
10 Automotive measuring system and real-time tariffmeter
101 Telematics aggregation engine
1011 Telematics-driven core aggregator
1012 Telematics data-driven triggers
1013 Data pre-processing module
1014 Univariate and/or bivariate data exploration module
1015 Dimensionality reduction module
102 Persistence storage
103 Persistence storage
1031 Correlation based features selection
10311, . . . , 1031i Selected features
1032 Principal component processing/analysis
10321, . . . , 1032i Processed components
104 Interface
105 Risk score generator
1051 Risk-indexing measurand/Risk score value
1052 Relative risk measure value
106 Tariffmeter
1061 Tarif value
10611 Base value of tariff
10612 Slightly adapted base tariff value
10613 Reduced based tariff value
10614 Increased based tariff value
1062 Tarif indicator
2 Data transmission network
20 Cellular network grid
201, . . . , 203 Network cell/Basic service area
211, . . . , 213 Base (transceiver) station
2111, . . . , 2131 Cell Global Identity (CGI)
221, . . . , 225 Mobile network nodes
21 Uni- or bidirectional data link
3 Telematic data/Sensory data
31 Vehicle features and usage parameter values and data
311 Frequency
312 Severity
313 Measuring time stamp
32 Driver behavior parameter values and data
321 Frequency
322 Severity
323 Measuring time stamp
33 Contextual and trip-related parameter values and data
331 Frequency
332 Severity
333 Measuring time stamp
34 Aggregated telematics data set
4 Motor vehicles
40 On-board sensors and measuring devices
401 Exteroceptive sensors or measuring devices
4011 Sensory data of the exteroceptive sensors
4012 Global Positioning System (GPS)
4013 Ultrasonic sensors
4014 Odometry sensors
4015 LIDAR (light detection and ranging)
4016 Video cameras
4017 Radar Sensors
4018 Infrared Sensors
402 Proprioceptive sensors or measuring devices
4021 Sensory data of the proprioceptive sensors
4022 Motor speed sensing
4023 Wheel load sensing
4024 Heading sensing
4025 Battery status sensing
41 OEM (Original Equipment Manufacturer) devices
42 Data transmission bus of the vehicle
421 Interface to the data transmission bus of the vehicle
43 On-board diagnostic system
44 In-car interactive device
45 Telematics devices with on board computer unit
451 Mobile automotive car system (also ref. no. 10)
452 Mobile phones
4521 Smart phones
4522 Cellular mobile phones
4523 Cellular mobile node application
453 Human-Interfaces
4531 Speakers
4532 Microphones
4533 Device alerts drivers
4534 Touchscreen
4535 Alphanumeric keyboard
4536 Language unit
454 Wireless connections
4541 Radio data systems (RDS) modules
4542 Positioning system modules (GPS)
4543 Mobile cellular telephone interface
4544 Satellite receiving module
4545 WLAN
4546 Bluetooth
5 User/Vehicle driver
6 Automated risk-transfer system (Insurance system)
61 Automated resource pooling system
62 Data store
621 Risk-transfers
622 Payment parameters
623 Aggregated payment parameter value
63 Payment transfer modules
64 Aggregated risk exposure
641 Predefined characteristics of accident events
642 Occurred and measured accident events
6421 Measured accident frequency
6422 Measured accident severity
642 Transferred risk exposures of the motor vehicles
6421 Risk transfer parameters
6422 Payment transfer (premium) parameters
643 Occurred loss associated with the motor vehicles
6431 Aggregated loss value
644 Variable loss ratio value
6441 Loss ratio threshold value

1. An automated, fully embedded, machine-learning-based measuring system for measuring a risk-indexing measurand based on directly measured connected motor vehicle sensory data of a plurality of motor vehicles with associated telematics devices, the telematics devices comprising one or more wireless connections to a data transmission network, and at least one interface for connection with at least one vehicle's data transmission bus and/or a plurality of interfaces for connection with sensors and/or measuring devices, wherein the telematics devices capture telematics and/or sensory data comprising vehicle features and usage parameter values and driver behavior parameter values and contextual and trip-related parameter values of the motor vehicle and/or driver,
the system comprising:
processing circuitry configured to implement
a data pre-processing module identifying representative signals by filtering for relevant signals and providing data cleaning by removing noisy data and outliers from a measured telematics and/or sensory data of the connected motor vehicle, wherein the data pre-processing module monitors and automatically detects different patterns of missing data, which can be detected by the data pre-processing module using threshold triggers and pattern recognition for detecting distribution characteristics of the missing data of a processed data set, and triggers a suitable imputation processing for the data set,
a data exploration module for associating and interpreting the filtered signals in their context, and
a dimensionality reduction module reducing the signals to signals having a significance in respect to the risk-indexing measurand measuring a risk as a probability value for the occurrence of an accident event having a physical impact with a measurable damage to the vehicle and/or driver, wherein the number of variables to be used as input to an accident risk modelling structure is reduced using feature selection and feature extraction means, the feature selection means selecting prominent variables using correlation-based feature selection and principal component analysis-based feature extraction, and the feature extraction means transforming high dimensional data into fewer dimensions to be used in the modelling process, and
wherein for the measuring of the risk-indexing measurand, the data pre-processing module and/or the data exploration module and/or the dimensionality reduction module are based on a set of machine-learning structures, transmitting their output values as input to a risk-score generator, the risk-score generator generating the risk-indexing measurand, and comprising a predictive accident risk modelling structure at least comprising, as predictive accident risk modelling structures, multiple linear regression and/or REPTree and/or random tree and/or multilayer perceptron.

2. The automated, fully embedded, machine-learning-based measuring system according to claim 1, wherein the measuring of the risk-indexing measurand is at least based on measuring the contribution given by (i) a vehicle component capturing which vehicle systems are present and activated or deactivated, (ii) a driver component at least capturing harsh maneuvers and/or excess of speed and/or risky behaviors and/or distraction, and (iii) a contextual component, the telematics data being enriched with additional data layers to capture location-based risks.

3. The automated, fully embedded, machine-learning-based measuring system according to claim 1, wherein the risk-indexing measurand capturing the risk of the occurrence of an accident event provides a measure of riskiness of a driver driving a certain vehicle in a certain context in a certain way.

4. The automated, fully embedded, machine-learning-based measuring system according to claim 1, wherein the system comprises a telematics aggregation engine capturing and aggregating the telematics data by a telematics-driven core aggregator with telematics data-driven triggers generating telematics data sets, wherein the capturing of the telematics data is triggered by detecting a change of a status of the vehicle at a point in time, the status being given by the values of the vehicle features and usage parameter and driver behavior parameter and contextual and trip-related parameter at said point in time, and wherein the change of the status is induced due to actions and/or reaction of the driver and/or due to the context in which the driver is driving and the way the driver perceives and feels the surroundings, respectively, and/or the way the vehicle adapts to internal and external conditions including the behavior of the driver.

5. The automated, fully embedded, machine-learning-based measuring system according to claim 4, wherein the aggregated telematics data sets comprise a plurality of processed risk-related or risk-transfer-related (insurance) attributes, and wherein the attribute values capturing characteristics of the vehicle driving by the driver having a significance in respect to the risk-indexing measurand indicative of a risk of the occurrence of an accident event having an impact to the vehicle and/or driver and/or characteristics having a significance in respect to a risk-transfer from the driver to a risk-transfer system.

6. The automated, fully embedded, machine-learning-based measuring system according to claim 1, wherein further the risk-score generator is based on one or more machine-learning structures for generating the risk-indexing measurand.

7. The automated, fully embedded, machine-learning-based measuring system according to claim 1, wherein the system comprises further a tariffmeter generating dynamically a variable tariff value for a risk-transfer from a certain driver to an automated risk-transfer system in respect to an aggregated risk exposure of transferred risks to said automated risk-transfer system from the vehicles.

8. The automated, fully embedded, machine-learning-based measuring system according to claim 7, wherein a driver's tariff value is generated starting from the base tariff value by dynamically varying the base tariff value based on the measured vehicle features and usage parameter values and driver behavior parameter values and contextual and trip-related parameter values in respect to their measured frequency and severity at a certain time.

9. The automated, fully embedded, machine-learning-based measuring system according to claim 8, wherein the tariffmeter comprises a tariff indicator dynamically indicating the present driver's tariff value at least indicating a not adjusted base tariff value and/or a slightly adjusted base tariff value and/or a reduced base tariff value and/or an increased base tariff value.

10. The automated, fully embedded, machine-learning-based measuring system according to claim 1, wherein the telematics devices are connected to an on-board diagnostic system and/or an in-car interactive device and/or a monitoring cellular mobile node application.

11. The automated, fully embedded, machine-learning-based measuring system according to claim 1, wherein machine-learning based system comprises one or more risk-transfer systems to provide risk-transfers based on risk transfer parameters from at least some of the motor vehicles to the risk-transfer systems, and wherein the risk-transfer systems comprise a plurality of payment transfer modules configured to receive and store monetary payment parameters associated with risk-transfer of risk exposures of said motor vehicles for pooling of their risks.

12. The automated, fully embedded, machine-learning-based measuring system according to claim 1, wherein the aggregated essentially directly measured connected motor vehicle sensory data of a plurality of motor vehicles are enriched by sensory data of a mobile device of the driver, the mobile device at least comprising a smart phone or a cellular mobile phone associatable with the specific driver.

13. A method, implemented by processing circuitry of an automated, fully embedded, machine-learning-based measuring system for measuring a risk-indexing measurand based on directly measured connected motor vehicle sensory data of a plurality of motor vehicles with associated telematics devices, the telematics devices comprising one or more wireless connections to a data transmission network, and at least one interface for connection with at least one vehicle's data transmission bus and/or a plurality of interfaces for connection with sensors and/or measuring devices, wherein the telematics devices capture telematics and/or sensory data comprising vehicle features and usage parameter values and driver behavior parameter values and contextual and trip-related parameter values of the motor vehicle and/or driver, the method comprising:
identifying, by a data pre-processing module implemented by the processing circuitry, representative signals by filtering for relevant signals and providing data cleaning by removing noisy data and outliers from a measured telematics and/or sensory data of the connected motor vehicle, wherein the data pre-processing module monitors and automatically detects different patterns of missing data, which can be detected by the data pre-processing module using threshold triggers and pattern recognition for detecting distribution characteristics of the missing data of a processed data set, and triggers a suitable imputation processing for the data set;
associating and interpreting, by a data exploration module implemented by the processing circuitry, for the filtered signals in their context; and
reducing, by a dimensionality reduction module implemented by the processing circuitry, the signals to signals having a significance in respect to the risk-indexing measurand measuring a risk as a probability value for the occurrence of an accident event having a physical impact with a measurable damage to the vehicle and/or driver, wherein the number of variables to be used as input to an accident risk modelling structure is reduced using feature selection and feature extraction means, the feature selection means selecting prominent variables using correlation-based feature selection and principal component analysis-based feature extraction, and the feature extraction means transforming high dimensional data into fewer dimensions to be used in the modelling process, and
wherein for the measuring of the risk-indexing measurand, the data pre-processing module and/or the data exploration module and/or the dimensionality reduction module are based on a set of machine-learning structures, transmitting their output values as input to a risk-score generator, the risk-score generator generating the risk-indexing measurand, and comprising a predictive accident risk modelling structure at least comprising, as predictive accident risk modelling structures, multiple linear regression and/or REPTree and/or random tree and/or multilayer perceptron.
